(19) United States
(12) Patent Application Publication
(10) Pub. No.: US 2011/0188234 A1
(43) Pub. Date: Aug. 4, 2011

(54) Light fixtures for converting man-made light into renewable energy

(76) Inventor: Raymond Saluccio, Colonia, NJ (US)

(21) Appl. No.: 12/658,026

(22) Filed: Feb. 1, 2010

(51) Int. Cl. F21L 4/00

(52) U.S. Cl. 362/183

(57) ABSTRACT

A light fixture assembly is provided for converting man-made light into renewable energy. The light fixture assembly is for indoor and outdoor use and has a housing and a ballast therein, and the conventional electrical components, including electrical contacts for the fluorescent light bulbs or other bulbs. One or more photovoltaic members or cells are mounted inside the light fixture assembly to collect the man-made light produced by the light fixture assembly, and generate electricity. An inverter is connected to the photovoltaic members to receive the electricity produced by the light fixture assembly.

### FIELD OF THE INVENTION

The technical field of this invention concerns collecting light from lighting fixtures using photovoltaic cells to generate reusable electricity.

### BACKGROUND OF THE INVENTION

Photovoltaic cells are a device that converts light into energy commonly associated with sunlight. The method of utilizing solar electric light producing fixtures reduces the cost of solar electric overall. All solar modules or cells that capture sunlight have a sheet of expensive glass on the front to protect them from the outside weather elements. There are other expenses to protect the outdoor solar cell, such as aluminum framing and oxide coatings in order to withstand the harsh environment they encounter, and also to maintain a moisture-free encasement. These added expenses are eliminated with the present invention which uses photovoltaic cells in all types of lighting fixtures, such as fluorescent fixtures, and other conventional light fixtures.

This invention reduces the cost of conventional solar electric significantly enough to make it an economical source of renewable electric energy. To date, the cost of solar energy has hampered human consumption of this specific source of renewable energy. In addition, the present invention collects man-made light at a cooler temperature than direct sunlight; therefore, the man-made light fixture of the present invention is more efficient, as the heat build-up reduces the energy output of all solar cells.

### OBJECTS OF THE PRESENT INVENTION

It is an object of the present invention to provide a method of absorbing man-made light within existing lighting fixtures, or a newly designed fixture, using photovoltaic cells integrated within the light fixture, and is suitable for mass production manufacturing.

It is an object of the present invention to generate electricity by the light absorption and collection of the man-made light produced within a lighting fixture, including incandescent light, L.E.D. lighting, vapor lighting, fluorescent lighting, or conventional light fixtures.

### SUMMARY OF THE INVENTION

A light fixture assembly is provided for converting man-made light into renewable energy. The light fixture assembly is for indoor and outdoor use and has a housing and a ballast therein, and the conventional electrical components, including electrical contacts for the fluorescent light bulbs or other bulbs. One or more photovoltaic members or cells are mounted inside the light fixture assembly to collect the man-made light produced by the light fixture assembly, and generate electricity. An inverter is connected to the photovoltaic members to receive the electricity produced by the light fixture assembly.

### BRIEF DESCRIPTION OF THE DRAWINGS

FIG. 1 is a perspective view of a light fixture including photovoltaic cells 20 for collecting man-made light from the fluorescent bulbs 16 to convert the light energy to electricity;

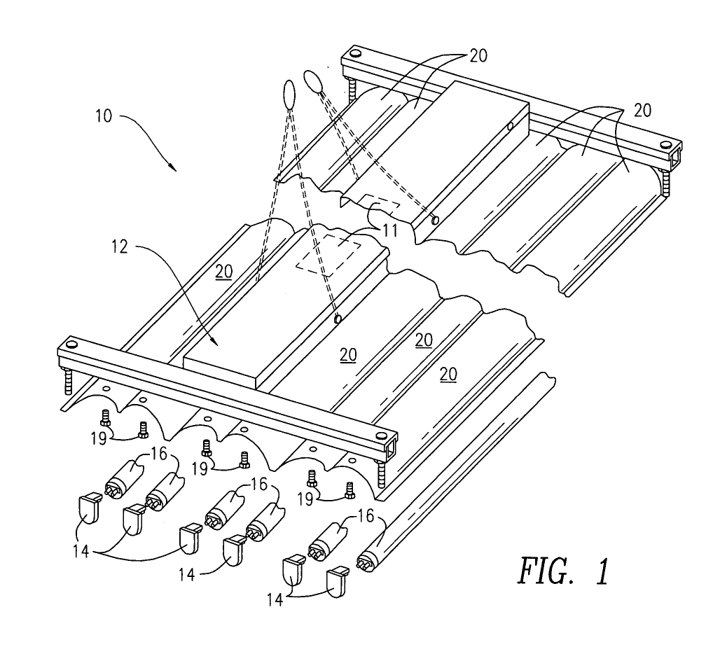

FIG. 2 is a perspective view of another embodiment of a retrofitted light fixture including photovoltaic cells 20′ for collecting man-made light from the fluorescent bulbs 16 to convert the light energy to electricity;

FIG. 3 is a perspective view of a photovoltaic cell for receiving light, having a plurality of internal layers A through F;

FIG. 4 is a perspective view of a plurality of photovoltaic cells for receiving light; and

FIG. 5 is an elevational view of the steps from making a photovoltaic cell.

### DETAILED DESCRIPTION OF THE PREFERRED EMBODIMENTS

A light fixture assembly 10 is provided for converting man-made light into renewable energy. The light fixture assembly 10 is for indoor and outdoor use and has a housing 12 and a ballast therein, and the conventional electrical components, including electrical contacts 14 for the fluorescent light bulbs 16 or other bulbs. One or more photovoltaic members or cells 20 are mounted inside the light fixture assembly 10 to collect and absorb the man-made light produced by the light fixture assembly, and to generate electricity. An inverter 30 is connected to the photovoltaic members 20 to receive the electricity produced by the light fixture assembly 10.

This absorption of light to energy can be performed by many methods of photovoltaic cells, such as, but not limited to, conventional solar modules, as well as thin film solar, categorized as:

Amorphous silicon—and other thin film silicon;

Cadmium Telluride—copper indium gallium selenide; and

Dye-sensitized solar and other devices of this type.

The above examples of photovoltaic materials collect and absorb the man-made light for electrical renewable energy generation to be supplied to the electricity grid using inverters (grid-connected photovoltaic systems). In stand-alone systems, batteries are used to store the electricity that is not needed immediately. The electric producing lighting fixtures of the present invention can be productive as stand-alone units, or connected in series to create additional voltage.

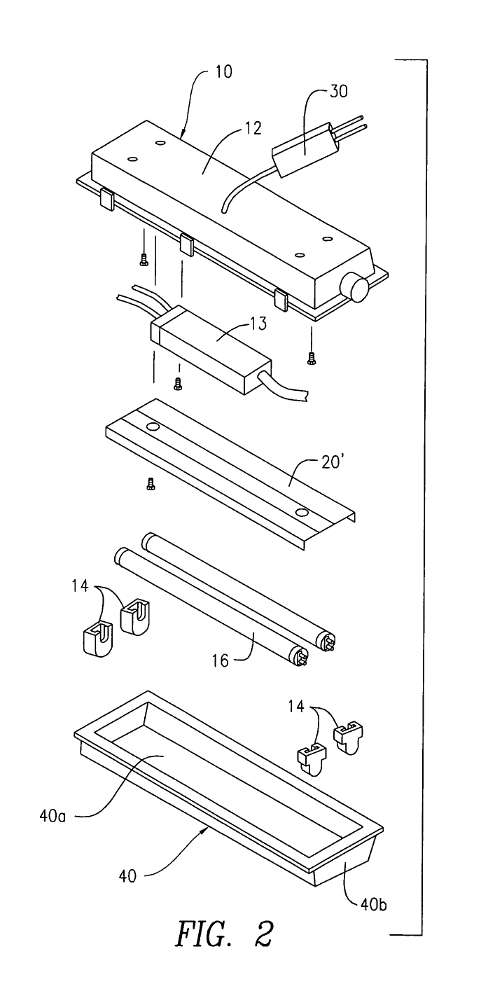

FIG. 2 shows a light fixture 10′ retrofitted with photovoltaic inserts 20′ which can be fabricated into select sizes and shapes to fit into any fluorescent, halogen, incandescent, or vapor lighting fixtures. The method of installation of the photovoltaic inserts 20′ as comprised of a series of energy-producing photovoltaic cells, which are installed by using mechanical and/or adhesive methods, or any other suitable methods.

FIG. 2 also shows a lower cover 40 having a bottom wall 40a and four side walls 40b, which are translucent and also absorb and collect light, which is transmitted to the photovoltaic members 20′. In this manner, the amount of man-made light collected is substantially increased since the light is being collected from above and below the light bulbs and from all sides.

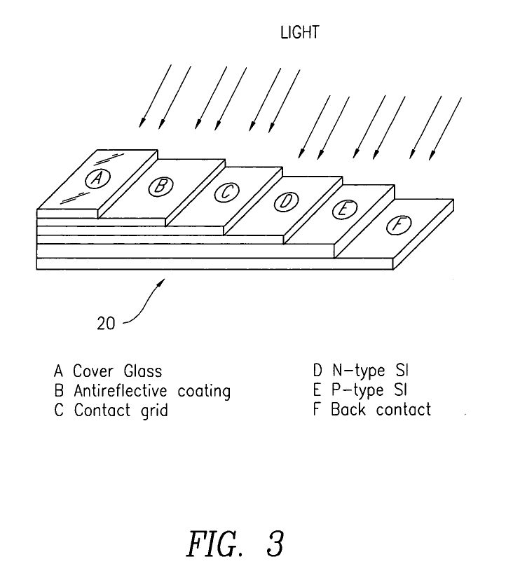

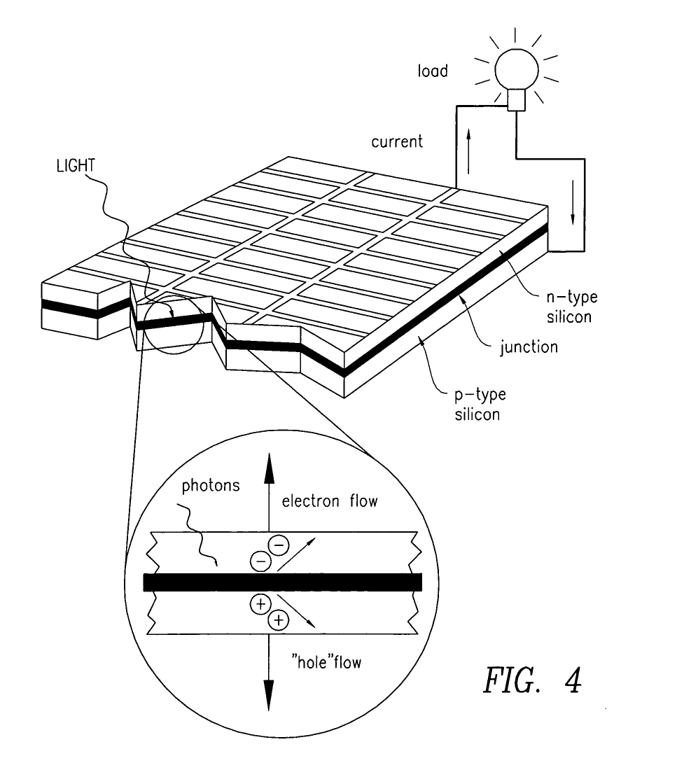

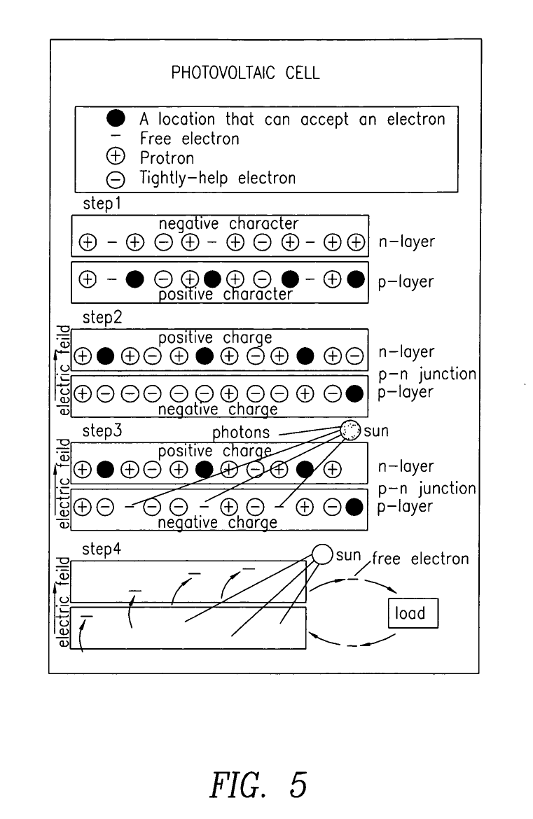

FIGS. 3, 4, and 5 show the internal structure and layers of a typical photovoltaic cell 20 or insert 20′, which may be used in the present invention.

For example, individual cells may vary in size from about 0.5 inches each to about 4 inches across, and one cell only produces 1 or 2 watts. However, if 50 cells are used, the wattage increases to 100 watts. Further, if a typical building has 1000 lighting fixtures, each producing approximately 100 watts, the amount of light energy produced is 100,000 watts, which is equivalent to 100 kilowatts. Further, to increase the power output, the photovoltaic cells may be electrically-connected into a tight module, and the modules can be further connected to form an array.

Photovoltaic cells 20 or 20′, like batteries, generate DC current, which is generally used for small loads. When DC current is produced, it can be converted to AC current using inverters, which are solid-state devices which convert DC power to AC power.

What is claimed:

1) A light fixture assembly for converting man-made light into renewable energy, comprising:
a) a light fixture assembly having a housing therein, and electrical components;
b) one or more photovoltaic members mounted inside said light fixture assembly to collect and absorb the man-made light produced by said light fixture assembly; and
c) an inverter connected to said photovoltaic members to receive the electricity produced by the light fixture assembly.

2) A Light fixture assembly in accordance with claim 1, wherein said light fixture assembly is a fluorescent light assembly, an incandescent light, an L.E.D. lighting fixture, a vapor lighting fixture, or any conventional lighting fixture.

3) A Light fixture assembly in accordance with claim 1, wherein said light fixture assembly includes an inverter for converting DC current to AC current
